(19) United States
(12) Patent Application Publication
(10) Pub. No.: US 2012/0187171 A1
(43) Pub. Date: Jul. 26, 2012

(54) FLOW-OPTIMIZED HOUSING ON THE FRONT WINDSHIELD OF A MOTOR VEHICLE

(75) Inventors: HANS ROHRMÜLLER, MAISACH (DE); GÜNTER GERLACH, KARLSFELD (DE)

(73) Assignee: MAN TRUCK & BUS AG, MUENCHEN (DE)

(21) Appl. No.: 13/354,549

(22) Filed: Jan. 20, 2012

(30) Foreign Application Priority Data
Jan. 20, 2011 (DE) 10 2011 008 969.1

(51) Int. Cl. B60R 11/00

(52) U.S. Cl. 224/545

(57) ABSTRACT

A passenger compartment element of a motor vehicle has a housing in which at a functional component is provided. The passenger compartment element is disposed in a passenger compartment, on or behind an inner side of a front windshield in a region through which an airstream which is directed at least in certain sections onto the inner side of the front windshield flows from an air outlet opening at least temporarily. The passenger compartment element is distinguished in that the housing has an outer contour which is rounded and fluidically optimized with respect to its being flowed around by the airstream directed onto the inner side of the front windshield. The cross-sectional surface of the outer contour, against which cross-sectional surface a part of the airstream flowing along or at least virtually parallel to the front windshield flows, is larger than a cross-sectional surface lying in the flow-off region.

### CROSS-REFERENCE TO RELATED APPLICATION

This application claims the priority, under 35 U.S.C. §119, of German application DE 10 2011 008 969.1, filed Jan. 20, 2011; the prior application is herewith incorporated by reference in its entirety

### BACKGROUND OF THE INVENTION

### Field of the Invention

The invention relates to a passenger compartment element of a motor vehicle, in particular a utility vehicle, having a housing, in which at least one electric and/or electronic functional component is provided or integrated and which is arranged in the passenger compartment of the motor vehicle, in particular a utility vehicle, on or behind an inner side of a vehicle front windshield in a region through which an airstream which is directed at least in certain sections onto the inner side of the vehicle front windshield flows from at least one air nozzle at least temporarily.

In the field of motor vehicle engineering, a large number of electric and electronic components are known which are attached from the inside to or behind the vehicle front windshield. Such components are, for example, cameras, sensors, chip card readers, compass systems, navigation systems, clocks, antennas and/or system elements for toll detection etc., depending on the respective equipment of the vehicle. In this context, for example in the case of utility vehicles, in particular in the case of heavy trucks and buses, sensor elements for automatic adaptive cruise control systems (ACC) and/or for lane detection and/or lane keeping systems (lane guard system) are often mounted on or behind the inner side of a vehicle front windshield.

Mounting electric or electronic components on or behind the inner side of a vehicle front windshield provides, in particular, the advantage that damage to the components is largely avoided. Furthermore, as a rule no additional devices for cleaning the field of vision is required, in particular for optical sensors and cameras, since these components usually lie in the wiping field of the windshield wipers which are provided on the outside of a vehicle front windshield. The sensors, cameras or transmitters which are often provided on or behind the inner side of the vehicle front windshield in lorries are preferably mounted in the region of the wiping field, and here in the lower region of the vehicle front windshield.

In this context, published, non-prosecuted German patent application DE 10 2007 012 993 A1, corresponding to U.S. patent publication No. 20070216768, discloses a system for mounting a camera within a vehicle. In the described technical solution, the camera is arranged inside the vehicle behind a special window which is permeable to infrared radiation and is let into the vehicle front windshield. The camera is covered with respect to the passenger compartment by a housing, wherein the camera is positioned between the vehicle front windshield and the housing in such a way that the field of vision of the camera is directed through the window which is permeable to infrared radiation. The housing which is used is of L-shaped design and is attached to the vehicle front windshield adjacent to the roof inner lining in an upper region of the vehicle front windshield. The field of vision of the camera is also located in the wiping field of the windshield wiper here so that it can always be kept free of dirt.

Furthermore, published, non-prosecuted German patent application DE 10 2005 002 686 A1 discloses a housing which is arranged behind a vehicle windshield and which can accommodate a camera, sensors for chip cards or other systems. The described housing is distinguished, in particular, by the fact that it has a flap which makes the interior of the housing easily accessible in order, for example, to clean the vehicle windshield behind the housing or to repair or replace components arranged inside the housing. The housing is arranged directly on the inner side of a vehicle front windshield, a cross-section surface increasing markedly in the direction of the inner roof lining.

It is problematic when attaching electric or electronic components or their housings in the region of the inner side of the vehicle front windshields not only in that they restrict the driver's field of vision but also that they are arranged directly in the flow region of the air nozzles which direct fresh air onto the inner side of the vehicle front windshield. The fresh air which is directed onto the inner side of a vehicle front windshield is usually conditioned in terms of its state parameters in such a way that the inner side of the windshield is kept free of water or the formation of ice, in particular on the outer side of the windshield, is avoided. In this context, front windshield defrosting is carried out, usually by means of an air-conditioned airstream which emerges from air nozzles or air outflow openings which are mounted in the direct vicinity of the front windshield on the instrument panel or on an adjoining panel, and flows upward along the front windshield. Components or the housings thereof which are located in the direct airstream along the inner side of the front windshield have in some cases a considerable negative influence on this airstream.

Owing to the housing geometries which are usually configured only with a view to accommodating electric and/or electronic components and restricting a vehicle driver's field of vision to a minimum extent, problems often occur with the defrosting of the windshield, dicing of the windshield or even with the heating of the windshield. These problems can even be so severe that at least in certain regions of the vehicle front windshield an undesired layer of ice is formed on the outer side of the front windshield under corresponding conditions.

Proceeding from the technical solutions which are known from the prior art and the problems with the known systems, the invention is based on the object of specifying a passenger compartment element with electric and/or electronic components by which the flow of air along the inner side of a vehicle front windshield is not influenced or is only influenced to a minimum degree. The solution which is to be specified will, in particular, ensure that, on the one hand, the airflow along the inner side of the vehicle front windshield is disrupted to the smallest possible extent and, on the other hand, that regions around which the airstream does not flow are kept as small as possible. This is intended to ensure that at all times reliable defrosting, deicing and heating of the vehicle front windshield is ensured despite the provision of the often unavoidable electric or electronic components on the inner side of a vehicle front windshield.

### SUMMARY OF THE INVENTION

It is accordingly an object of the invention to provide a flow-optimized housing on the front windshield of a motor vehicle which overcomes the above-mentioned disadvantages of the prior art devices of this general type.

According to the invention, a passenger compartment element of a motor vehicle or for a motor vehicle has a housing, in which at least one electric and/or electronic functional component is provided. The passenger compartment element is arranged in the passenger compartment of the vehicle, on or behind an inner side of a vehicle front windshield in a region through which an airstream which is directed at least in certain sections onto the inner side of the vehicle front windshield flows from at least one air nozzle at least temporarily. The passenger compartment element is developed in such a way that the housing has an outer contour which is rounded and/or fluidically optimized with respect to its being flowed around by the airstream directed onto the inner side of the vehicle front windshield. A cross-sectional surface of the outer contour, against which cross- sectional surface a part of the airstream flowing along or at least virtually parallel to the vehicle front windshield flows, is larger than a cross-sectional surface lying in the flow-off region of the housing.

The housing is preferably optimized with respect to the fluidic configuration in such a way that an extent of the outer contour in the transverse direction with respect to a part of the airstream flowing along or at least virtually parallel to the vehicle front windshield is smaller than in the direction of flow. In this case, the passenger compartment element according to the invention having a housing in which an electric and/or electronic functional component is provided is distinguished by the fact that the outer contour is given a comparatively long extent in the longitudinal direction of the airflow compared to its cross-sectional surface. The surface against which there is a flow, which is oriented transversely with respect to the airstream or the airflow, likewise has a slender outer contour.

In one specific embodiment of the invention, the housing has an at least partially droplet-shaped outer contour or a contour which is droplet-shaped at least in certain sections. Here, the passenger compartment element which is embodied according to the invention, or the housing of the passenger compartment element, has a droplet shape whose cross-sectional surface changes continuously along the direction of flow of the airstream and becomes much smaller in particular in the flow-off region of the housing. A rounded edge, which is arranged at least virtually perpendicularly with respect to the windshield and in which the side wall surfaces of the housing run together, is preferably provided at the upper end of the housing facing the inner roof lining. Alternatively it is also conceivable to provide, in the flow-off region of the housing, a spoiler surface or a spoiler surface with rounded portions or shapes which are embodied in a suitable way. Possible conceivable shapes are, for example, the comb contours or Jaray contours which are known from vehicle bodywork construction and are used in particular for the rear parts of vehicles. Furthermore, it is optionally possible for individual surfaces, in particular the two side surfaces facing the outer sides of the vehicle front windshield or the A pillars, of the housing or else the entire housing to be contoured in a droplet shape. It is essential in each case that the outer contour of the housing tapers in the direction of flow of the airstream flowing along the window so that the partial airstreams flowing around the housing are joined in the flow-off region of the housing in such a way that no separation of the flow with the associated formation of eddying occurs here. The upper terminating edge of the housing, which forms a spoiler edge, is therefore embodied in such a way that at least two of the partial airstreams which flow around the housing are brought together on the lee side of this edge at an angle which is as acute as possible.

The geometry of the outer contour of the housing can also be embodied with optimized radii with respect to the flowing around by the airstream which flows virtually parallel to the vehicle front windshield. A partial droplet shape, which is implemented according to one preferred embodiment of the invention, is to be understood to mean that the housing does not have a droplet shape around its entire circumference because it adjoins, for example in its region facing the air outlet nozzles, an instrument panel or a component, in particular an interior component, which adjoins the latter. In this case, the housing can preferably also be attached directly to the instrument panel or to the component which adjoins the latter, in particular an interior component, so that the surface of the instrument panel merges directly with the outer wall of the housing.

In a further embodiment, the housing can be attached to the vehicle front windshield by, for example, a bonded connection or adhesive connection.

Alternatively, it is, of course, also conceivable for the housing of the passenger compartment element to be attached to the instrument panel or to the component adjoining it, in particular an interior component, with the aid of a suitably embodied holder, base and/or a component foot.

Given such an embodiment or such a way of attaching the passenger compartment element, it is particularly advantageous if the holder, base and/or the component foot are also of optimized configuration with respect to the fluidic configuration or have lining elements which are of a correspondingly suitable, flow- optimized design.

A further preferred embodiment provides that the housing of the passenger compartment element has a line feed which is connected to the housing and which supplies energy to the electric and/or electronic components and/or serves for the transmission of data.

Such a line feed is also of suitably flow-optimized design with respect to the airstream flowing at least virtually parallel to the inner side of the vehicle front windshield or is surrounded by a lining element which is of flow-optimized design.

In a housing according to the invention one or more electric and/or electronic components can optionally be provided. According to one advantageous development, there is provision in this context that the housing has, on an inner side of the side facing the vehicle front windshield, at least one opening for a sensor element of the at least one electric or electronic functional component. The opening which is provided serves, for example, as a field of vision for optical sensors, which field of vision is directed through the vehicle windshield and onto the road in front of the vehicle. If a plurality of components are provided within a fluidically optimized housing, they are preferably arranged one on top of the other in order thus to implement a housing contour which is embodied so as to be slender in the transverse direction with respect to the direction in which the airstream flows against the housing, and is embodied so as to be elongate in the direction of flow.

In a further embodiment of the present invention, the housing has, in the flow-off region, a spoiler surface at which virtually eddy-free detachment of the airflow can take place at least temporarily.

Other features which are considered as characteristic for the invention are set forth in the appended claims.

Although the invention is illustrated and described herein as embodied in a flow-optimized housing on the front windshield of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an instrument panel with an adjoining component and a functional component arranged thereon, with an optical sensor according to the prior art; and

FIG. 2 is a diagrammatic, perspective view of the instrument panel with the adjoining component and a housing which is arranged thereon and in which two electronic functional components are arranged according to the invention.

### DETAILED DESCRIPTION OF THE INVENTION

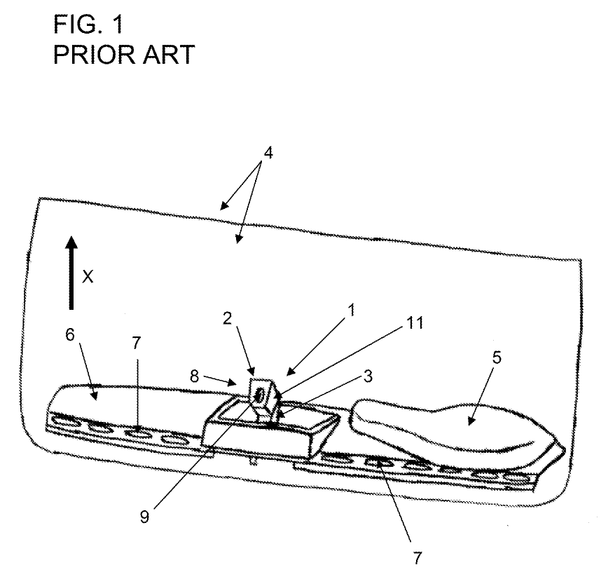

Referring now to the figures of the drawing in detail and first, particularly, to FIG. 1 thereof, there is shown a passenger compartment element 1 of a non-illustrated cab of a utility vehicle, as is known from the prior art. The illustration is of a view with a viewing direction from the front through a vehicle front windshield 4 of the utility vehicle's cab onto an instrument panel 5 with an adjoining component or interior component 6. The instrument panel 5 with the adjoining interior component 6 has, in the front region, air nozzles or suitably embodied air outflow openings 7 which are arranged virtually parallel to the inner side of the vehicle front windshield 4. In a central part of the interior component 6, a functional component 8 with a sensor element 9, in particular an optical sensor 9, which is arranged in a housing 2, is provided. The electronic component 8 which is illustrated is, for example, a camera of a lane detection system.

The markings which delimit the carriageway are sensed with the aid of such a camera 8 in order to implement automatic lane detection and/or lane keeping on the basis of corresponding data using an evaluation unit and/or control unit of a corresponding system.

In the lower region of the housing 2 a component foot 3 is provided by which the camera 8 is attached by its housing 2 to the interior component 6 of the utility vehicle's cab. It is clearly apparent here that the housing 2 has a comparatively angular outer contour (see for example side surface 11) and the component foot 3 also has regions in which airflow is not guided but instead eddying of the airflow can occur.

The airstream which emerges from the air nozzles and/or from suitable airstream outlet openings 7 is directed at least partially onto an inner side of the vehicle front windshield 4. The airstream, or at least a part of this airstream, therefore flows from the air nozzles or airstream outlet openings 7 along the inner side of the vehicle front windshield 4 and/or upwards at least virtually parallel thereto in a direction X of the upper side edge of the vehicle front windshield 4. With the side edge, the vehicle front windshield 4 usually adjoins a non-illustrated window strut.

A vehicle driver can regulate both the temperature and the volume stream of the airflow as a function of the ambient conditions and of the personal comfort requirements. In addition to a manual control there are often also automatic control systems provided which selectively set, as a function of the ambient conditions, the parameters of the air flowing out of the air nozzles or airstream outlet openings 7. For example the defrosting of the front windshield is therefore carried out by an airstream which is suitably conditioned in respect of its state parameters with the aid of a vehicle air-conditioning system. Conditioning the airstream is understood to mean in this context not only that the temperature of the airstream can be controlled to different degrees but also that its moisture content can be selectively set to a certain extent.

The provision of a camera unit or camera 8 in the flow region of the air flowing out of the air outlet openings 7 brings about a disruption in the airstream which is directed over the inner side of the vehicle front windshield 4 or at least virtually parallel thereto. This can lead to a situation in which defrosting, deicing and/or heating of the vehicle front windshield 4 does not take place to the necessary extent. In particular, either delays can occur during the defrosting or the deicing of the vehicle front windshield 4 or individual regions of the vehicle front windshield 4 are not at all subjected to the correspondingly conditioned airstream. The disruption of the airflow owing to the components 3, 8 which are arranged in the region of the inner side of the vehicle front windshield 4 can become so severe that the vehicle front windshield 4 is not heated to the necessary extent, in particular at low outer temperatures, and a layer of ice is formed on the outer side of the vehicle front windshield 4. This leads to the vehicle driver's vision being impaired and ultimately makes driving dangerous, in particular shortly after a cold start of the vehicle.

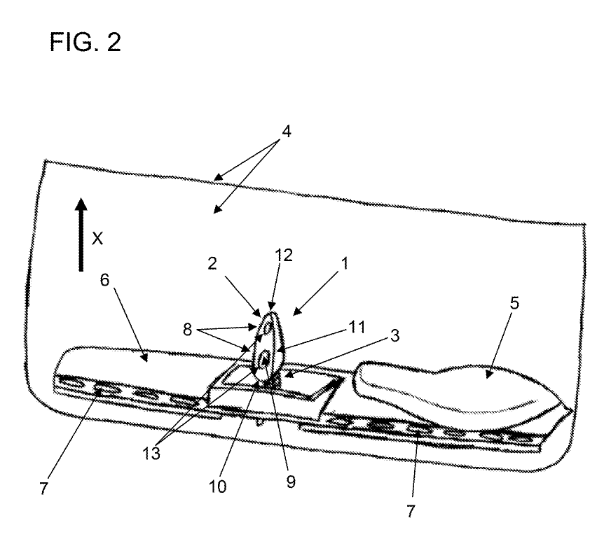

FIG. 2 illustrates the passenger compartment element 1 according to the invention in an embodiment. The passenger compartment element 1 has a housing 2 and two cameras 8 which are arranged therein as the functional elements 8. The cameras 8 each have at least one sensor element 9. In contrast to the technical solutions known from the prior art, the housing 2 is of a fluidically optimized design with respect to the airflow which flows along the inner side of the vehicle front windshield 4. The housing 2 which is illustrated in FIG. 2 is distinguished above all by the fact that the outer contour is comparatively elongated in the direction of flow of the airstream and the housing 2 is embodied so as to be slender in its flow-off region 12.

The illustrated housing 2 is embodied in a droplet shape, wherein cross sections and/or contour sections with optimized radii have been selected. The housing 2 can also be embodied at least in certain sections in a droplet shape or at least in certain sections in a cone shape or at least in certain sections in a spherical shape. In particular, the side surfaces 11 of the housing 2 in FIG. 2 follow the contour of a droplet in such a way that they run together in a rounded terminating edge in a flow-off region 12. As a result of the tapering of the housing cross-section in the direction of the flow-off region 12 and the equally rounded shape of the terminating edge it is ensured that, in particular, the partial airstreams which flow around along the side surfaces 11 of the housing 2 are joined together behind the terminating edge, in the lee side of the housing 2, so as to enclose an acute angle. The flow-off region 12 of the housing 2 constitutes the narrowest region, that is to say the region with the smallest cross-sectional surface of the housing 2.

Both the region 10 against which there is a flow and the terminating edge in the flow-off region 12 of the housing 2 are of rounded design. A central factor here is that the radius of the housing contour is chosen so as to be larger in the region 10 against which there is a flow than the radius of the outer contour in the flow-off region 12. In this way, at the same time a suitable flow around the housing 2 and minimization of the flow losses in the flow-off region 12, are achieved, in particular by largely preventing the formation of eddies behind the rounded terminating edge.

The housing 2 has, in its region 10 against which there is a flow, a small base 3 which connects the passenger compartment element 1 to the interior component 6 of the cab of the utility vehicle. The outer contour of the base 3 is adapted to the outer contour of the housing 2, with the result that the outer skin of the base 3 merges directly with the surface of the housing 2. The junction region between the interior component 6 and the housing 2 is also embodied in such a way that the airflow can flow at least virtually free of disruption or eddies along the surfaces around which there is a flow.

On the side of the housing 2 facing the vehicle front windshield 4, two openings 13 which are arranged one on top of the other are provided. The optics or the optical sensors 9 of the camera 8 of a lane detection or lane keeping system (lane guard system) and of the camera 8 of an adaptive cruise controller (ACC) are arranged directly behind these openings 13. The openings 13 form in this way the starting point for the field of vision of the two cameras 8 onto the road located in front of the vehicle, here a utility vehicle. The cameras 8 which are provided in the housing 2 which is embodied according to the invention are arranged one on top of the other. This arrangement in turn ensures that the housing 2 has a slender and elongated outer contour. The extent of the housing 2 is larger here in the direction of flow than in the transverse direction with respect to the airflow.

The passenger compartment element 1 with the housing 2 and the two cameras 8 arranged therein is also positioned behind the vehicle front windshield 4 in such a way that the airstream which emerges from the air nozzles or air outlet openings 7 and flows along the inner side of the vehicle front windshield 4 is virtually unaffected by any negative influence. For this purpose, the positioning of the air outlet openings 7 is advantageously matched to the positioning of the passenger compartment element 1. The surface of the housing 2 facing the vehicle front windshield 4 runs at least virtually parallel to the inner side of the vehicle front windshield 4. The housing 2 adjoins the vehicle front windshield 4, with a non-illustrated seal being provided between the vehicle front windshield and the housing. Alternatively it is conceivable to bond the housing 2 over the entire surface of the windshield. At the surfaces which do not face the vehicle front windshield 4, in particular the side surface 11, the airstream which emerges from the air outlet openings 7 flows around the housing 2, while at the same time a reliable flow over the inner side of the vehicle front windshield 4 is ensured.

The technical solution according to the invention makes available in a particular way a passenger compartment element 1 with a housing 2 which permits the arrangement of electric and/or electronic components 8 behind the vehicle front windshield 4 without the airstream which flows along the inner side of the vehicle front windshield 4 being permanently disrupted as a result. Ventilation of the vehicle front windshield 4 which is sufficient for any operating state, in particular for deicing, defrosting and/or heating, is therefore reliably ensured.

1. A passenger compartment element of a motor vehicle having a passenger compartment and a front windshield, the passenger compartment element comprising:
a functional component selected from the group consisting of electrical components and electronic components; and
a housing in which at least one said functional component is disposed, said housing disposed in the passenger compartment of the motor vehicle, on or behind an inner side of the front windshield of the motor vehicle in a region through which an airstream which is directed at least in certain sections onto the inner side of the front windshield flows from at least one air outlet opening at least temporarily, said housing having an outer contour being fluidically optimized with respect to its being flowed around by the airstream directed onto the inner side of the front windshield, said outer contour having a cross-sectional surface, against said cross-sectional surface a part of the airstream flowing along or at least virtually parallel to the front windshield flows, being larger than a cross-sectional surface lying in an flow-off region.

2. The passenger compartment element according to claim 1, wherein an extent of said outer contour in a transverse direction with respect to a part of the airstream flowing along or at least virtually parallel to the front windshield is smaller than in the direction of flow.

3. The passenger compartment element according to claim 1, wherein said housing has an at least partially droplet-shaped outer contour.

4. The passenger compartment element according to claim 1, wherein said housing adjoins one of an instrument panel or an interior component which adjoins the instrument panel.

5. The passenger compartment element according to claim 1, wherein said housing is attached to one of an instrument panel or to an interior component which adjoins the instrument panel.

6. The passenger compartment element according to claim 1, wherein said housing is attached to the front windshield.

7. The passenger compartment element according to claim 1, wherein said housing has a component foot being attachable on an outer side.

8. The passenger compartment element according to claim 1, further comprising a line feed connected to said housing.

9. The passenger compartment element according to claim 7, wherein said component foot has a flow-optimized design with respect to the airstream directed onto the inside of the front windshield.

10. The passenger compartment element according to claim 7, wherein said component foot has a lining element of a flow-optimized design with respect to the airstream directed onto the inside of the front windshield.

11. The passenger compartment element according to claim 8, wherein said line feed has a flow-optimized design with respect to the airstream directed onto the inside of the vehicle front windshield.

12. The passenger compartment element according to claim 7, wherein said line feed has a lining element of a flow-optimized design with respect to the airstream directed onto the inside of the front windshield.

13. The passenger compartment element according to claim 1, wherein:
said functional component has a sensor element; and
said housing has, on a side facing the front windshield, at least one opening formed therein for receiving said sensor element.

14. The passenger compartment element according to claim 1, wherein said housing has, in said flow-off region, a spoiler surface at which virtually eddy-free detachment of the airflow takes place at least temporarily.

15. The passenger compartment element according to claim 7, wherein said component foot is selected from the group consisting of a base and a holder.
